(19) United States
(12) Patent Application Publication
(10) Pub. No.: US 2024/0166370 A1
(43) Pub. Date: May 23, 2024

(54) PORT, MOBILE OBJECT, AND METHOD FOR INSTALLING PLURALITY OF PORTS

(71) Applicant: AERONEXT INC., Tokyo (JP)

(72) Inventor: Yoichi SUZUKI, Tokyo (JP)

(21) Appl. No.: 18/548,802

(22) PCT Filed: Feb. 24, 2022
(86) PCT No.: PCT/JP2022/007497

§ 371 Date: Sep. 1, 2023

(30) Foreign Application Priority Data
Mar. 2, 2021 (JP) 2021-032274

(51) Int. Cl. B64F 1/32; B64F 1/14

(52) U.S. Cl. CPC B64F 1/32; B64F 1/14

(57) ABSTRACT

A compact port with a simple mechanism that can improve reliability during load receiving while keeping costs low. A port of the disclosure is a port having a load-receiving part that rotates around a rotating axis extending at least in a vertical direction, wherein the load-receiving part rotates by switching between a load receiving mode and a standby mode based on an external control signal.

### TECHNICAL FIELD

This disclosure relates to a port, a moving object, and a method for installing a plurality of ports.

### BACKGROUND ART

In recent years, the practical application of home delivery services using flying objects such as drones and unmanned aerial vehicles (UAVs) (hereinafter collectively referred to as “flying objects”) has been promoted. Flying objects equipped with multiple propellers, commonly called multicopters (hereinafter collectively referred to as “multicopters”), do not require a runway for takeoff and landing as do ordinary fixed-wing aircraft, and thus can operate in relatively small areas, making them suitable for use in home delivery and other transportation services.

In transportation by flying objects, there are cases where individual delivery to a room in a house, apartment, building, hotel, etc. is desired. In order to make deliveries directly to the desired rooms, the use of windows and balconies is a well-known method of delivering packages. In single-family detached houses, there is also a method using the yard, but in some cases, it is difficult to operate because landing on the ground may cause contact with people or animals.

However, existing windows and balconies are generally equipped with structures such as window frames and railings, which are not suitable for flying objects to enter. In addition, if flying objects come into contact with the structure, it may lead to damage to the structure or flying objects. In view of this situation, Patent Literature 1 discloses a delivery and receiving device that enables delivery and receipt of packages by flying objects by installing a package receiving device on an exterior wall of a building (see, for example, Patent Literature 1).

### PRIOT ART LIST

### Patent Literature

[Patent Literature 1] JP6547084B1

### SUMMARY OF THE INVENTION

### Technical Problem

Ports (especially those provided by individuals) should have a simple mechanism from the viewpoint of simplicity of installation and cost. When rotation is performed around the X-axis or Y-axis as disclosed in Patent Literature 1, the force required may be stronger and/or the structure may be more complicated because the weight of the port's bearing portion supported by the rotating part is pulled up or down.

In addition, it is known that upwelling air currents can occur on the walls of buildings, and crosswinds can flow strongly along the wall surfaces. To improve the reliability of the grounding of cargo and flying objects, it is essential to reduce the effects of these air currents; if the X or Y axis is used as the pivot axis, the load may be applied in the direction of rotation of the pivot part when the distance between the cargo part and the structure is separated.

Therefore, one purpose of this disclosure is to provide a compact port that can improve reliability in receiving cargo with a simple mechanism and at a low cost.

### Technical Solution

According to the disclosure, it is possible to provide a port or the like characterized by having a load receiving part that rotates around a rotary axis extending at least in the vertical direction.

### Advantageous Effects

According to the disclosure, ports and other facilities can be provided that can improve reliability when receiving loads.

### BRIEF DESCRIPTION OF THE DRAWINGS

FIG. 1 shows a schematic view of the rotating port according to the disclosure, viewed from the top.

FIG. 2 shows a side view of the rotating port of FIG. 1.

FIG. 3 shows a schematic view of one of the configurations of the rotating port according to the disclosure, viewed from the top.

FIG. 4 shows a side view of the rotating port of FIG. 3.

FIG. 5 shows a schematic diagram of a flying object in the disclosure, viewed from the side.

FIG. 6 shows a view of the flying object of FIG. 5 when it is moving forward.

FIG. 7 shows a top view of the flying object of FIG. 5.

FIG. 8 shows a functional block diagram of the flying object of FIG. 1.

FIG. 9 shows a schematic diagram showing airflows impinging on a structure.

FIG. 10 shows a top view of the rotating port according to the disclosure in standby mode.

FIG. 11 shows a top view of the rotating port of FIG. 10 in the process of transitioning to the receiving mode.

FIG. 12 shows a top view of the rotating port of FIG. 10 in the load-receiving mode.

FIG. 13 shows a side view of the configuration where the flying object hangs the loading part.

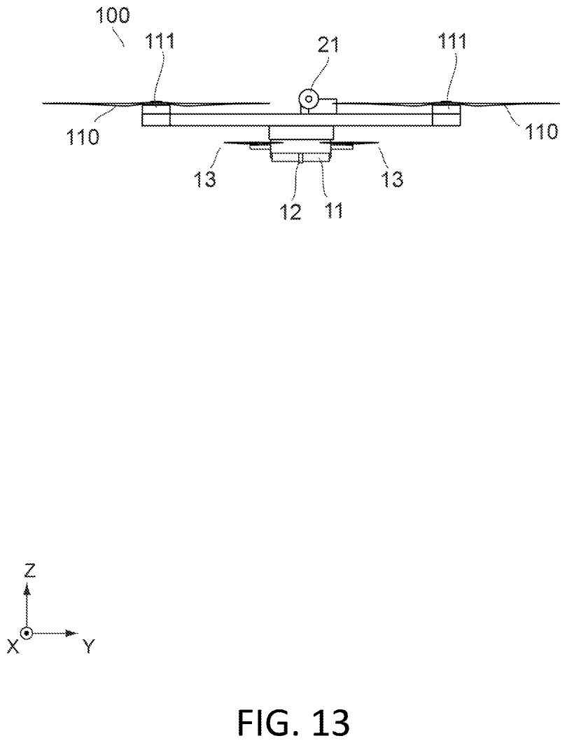

FIG. 14 shows a view of the flying object of FIG. 13 when it lowers the loading part.

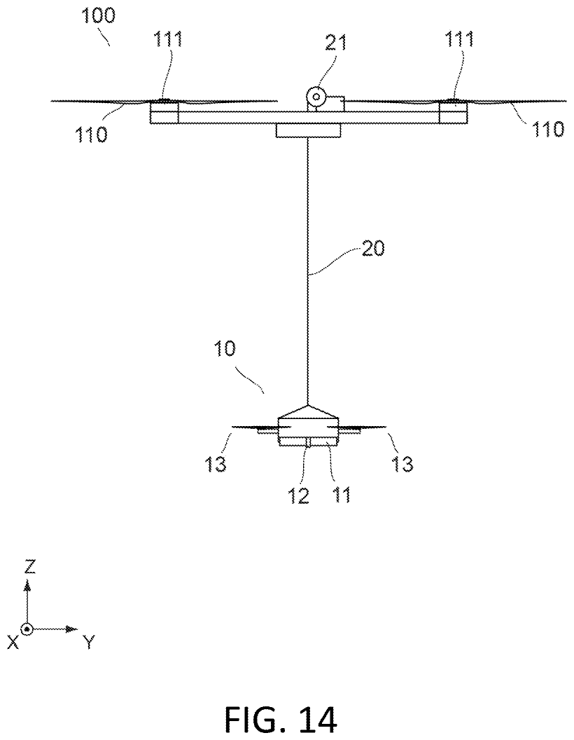

FIG. 15 shows another view of the flying object of FIG. 13 when it lowers the loading part.

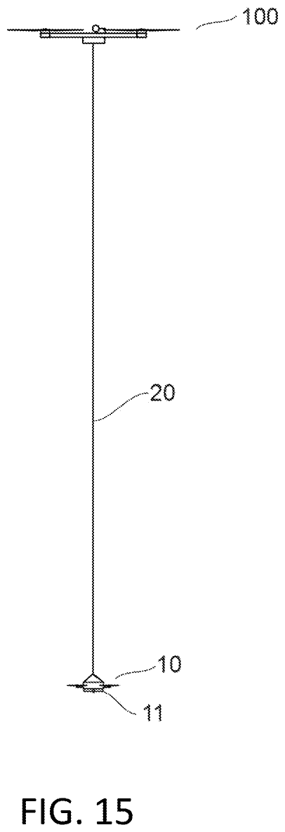

FIG. 16 shows an enlarged front view of the loading part of FIG. 13 as it reaches the port area.

FIG. 17 shows a view of the loading section of FIG. 13 when it releases its load.

FIG. 18 shows a view after the loading part of FIG. 13 finishes unloading the load.

FIG. 19 shows a view when the port of FIG. 13 has the anti-fall member protruding from the top.

FIG. 20 shows a top view of the port of FIG. 19.

FIG. 21 shows a side view of a port according to the disclosure.

FIG. 22 shows the port of FIG. 21 when the string member is cut.

FIG. 23 shows a top view of the port according to the disclosure when it has an elevator function.

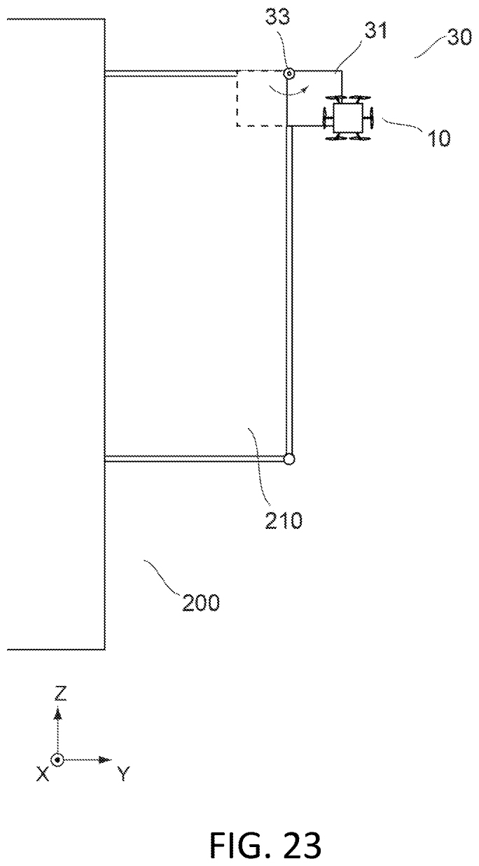

FIG. 24 shows a side view of the port of FIG. 23 when the elevator is descending.

FIG. 25 shows a top view of an example port configuration according to the disclosure.

FIG. 26 shows another top view of an example port configuration according to the disclosure.

FIG. 27 shows a top view of a port according to the disclosure when the port is a moving object.

FIG. 28 shows a side view of the port of FIG. 27.

FIG. 29 shows an example of the location of a port in a structure with multiple living rooms according to the present disclosure.

FIG. 30 shows a top view of a port according to the disclosure when the port is connected to a rail.

FIG. 31 shows a side view of the port of FIG. 30.

### DETAILED DESCRIPTION OF THE EMBODIMENTS

The following is a list and description of the contents of this embodiment of the disclosure. Ports and other equipment according to this embodiment of the disclosure comprise the following.

### [Item 1]

A port comprising: a load-receiving part that rotates around a rotating axis extending in at least a vertical direction,

wherein the load-receiving part is rotated to switch between a load-receiving mode and a standby mode based on an external control signal.

### [Item 2]

The port according to Item 1,

wherein the control signal is a control signal transmitted from a loading unit that is suspended from a flying object.

### [Item 3]

The port according to item 1,

wherein the control signal is a control signal transmitted from another port.

### [Item 4]

The port according to item 1,

wherein the control signal is a control signal transmitted from a flying object.

### [Item 5]

The port according to item 1,

wherein the control signal is a control signal transmitted from a management server that manages a delivery.

### [Item 6]

The port as in any one of items 1-5,

wherein the load-receiving part is connected to the rotating axis via a long support member.

### [Item 7]

The port according to item 6,

wherein the length of the long support member is longer than the length of the load-receiving part in the direction of extension of the support member.

### [Item 8]

The port according to item 6,

wherein the support member has a telescopic mechanism.

### [Item 9]

The port as in any one of items 1-8,

wherein the load-receiving part has an anti-fall member.

### [Item 10]

The port as in any one of items 1-9, further comprising:

a holding mechanism for holding a cord-like member from which a load or a loading part suspended from a flying object; and

a cutting mechanism for cutting the cord-like member.

### [Item 11]

A moving object provided with the port as in any one of items 1 to 10.

### [Item 12]

A method for installing a plurality of ports for arranging the ports as in any one of items 1-10 in a predetermined plurality of rooms of a building,

wherein each of the ports is arranged in the living rooms adjacent to each other in the upper and lower positions by shifting the X coordinate when viewed from above.

### [Item 13]

A moving body, comprising:

a load-receiving part that rotates around a rotating axis extending at least in a vertical direction,

wherein the load-receiving part is equipped with a rotating port that switches between a load-receiving mode and a standby mode based on an external control signal.

### [Item 14]

An installation method of multiple ports for arranging a port in a predetermined plurality of rooms of a building,

wherein the port comprises a load-receiving part that rotates around a rotating axis extending at least in a vertical direction,

wherein the load-receiving part is rotated to switch between a load-receiving mode and a standby mode based on an external control signal,

wherein, in living rooms adjacent to each other above and below, each of the ports is arranged in a staggered X-coordinate position when viewed from above.

### DETAILS OF EMBODIMENTS ACCORDING TO THIS DISCLOSURE

The following is a description of the port according to this embodiment of the invention, with reference to the drawings.

### Details of the First Embodiment

Ports, which are one of the destinations of flying objects, have been known as well-known technology, including pads or ports on the ground or rooftop, and ports on the windows or balconies of buildings. It is easy to install a port on the premises in a house or facility with a yard. However, when there is insufficient space for a port on the ground, or when delivery is to be made to a place where there is no land on the ground (e.g., a room in an apartment building with two or more floors above the ground, or an office in a building), a compact port that can be installed in a window or on a balcony is desired.

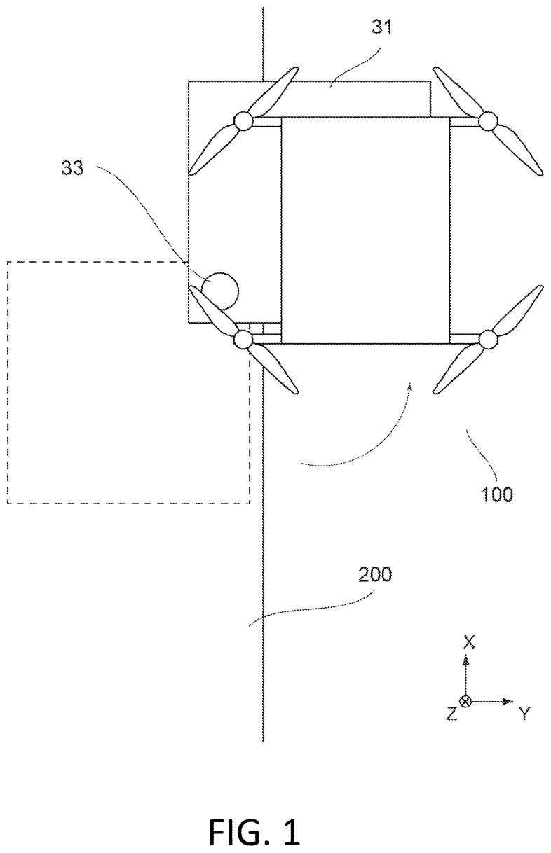

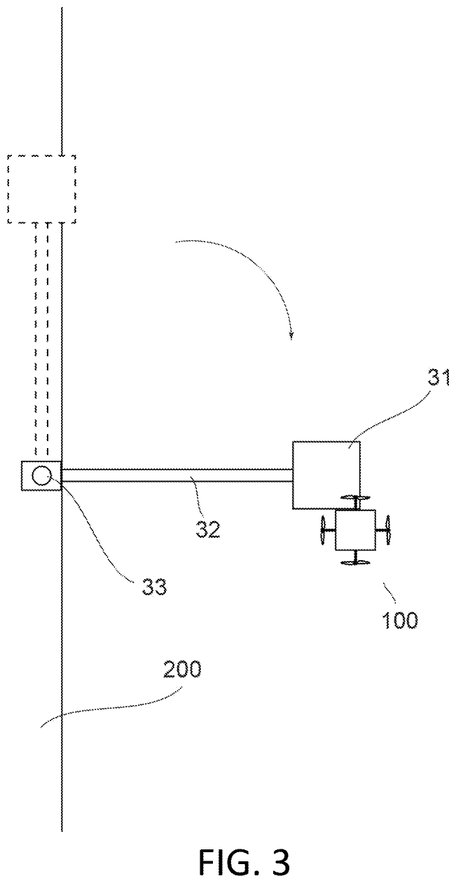

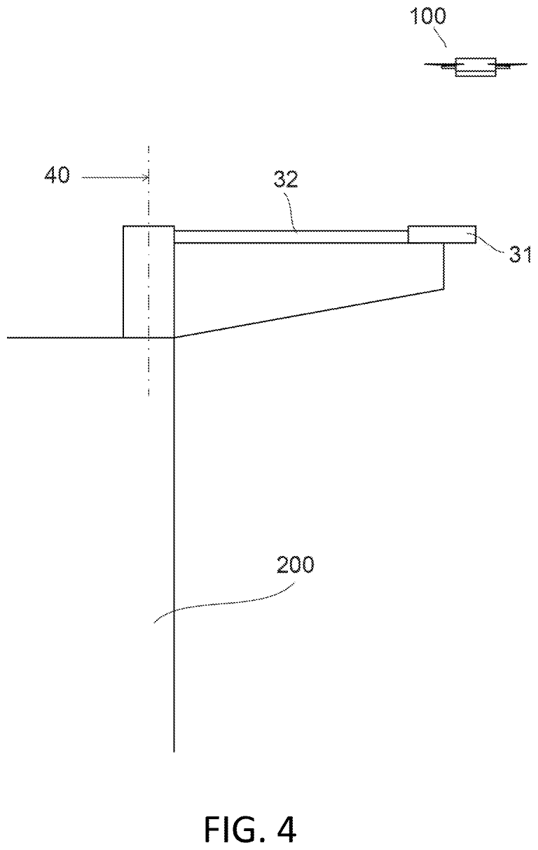

As shown in FIG. 1-FIG. 4, a port 30 in the disclosure comprises a load-receiving part 31 where a flying object 100 lands on or connects to and only a load 11 is received by being grounded or connected, and a rotating part 33 where the load-receiving part is rotated. The port 30 should be located on a balcony 210 or a veranda, a window, an exterior wall, a roof, a bridge, or a tower of a structure 200, or any other location that is easily accessible from above the structure 200. The port 30 may be movable to allow for temporary use, or it may be fixed to the structure to reduce the possibility of tipping over and improve reliability. When the distance between the load-receiving part 31 and the rotating part 33 is separated, a support member 32 may be provided to connect with and support the load-receiving and rotating parts.

A rotating axis of the rotating part 33 is extended in a direction that includes at least as much component in the Z direction as in the X and Y directions (i.e., the rotating axis is extended so that the angle between the rotating axis and the vertical Z axis is smaller than the angle between the rotating axis and the horizontal X or Y axis). This makes it possible to rotate with less force than when rotating about an axis extending in the X or Y direction. In addition, since the direction of extension of the rotating axis is substantially the same as the vertical direction, which is the direction of the load applied to the port 30 due to updrafts and the load of flying objects and loads of luggage, the load is greatly reduced.

As shown in FIG. 1-FIG. 4, the port 30 according to the embodiment of this disclosure is used in combination with a flying object 100.

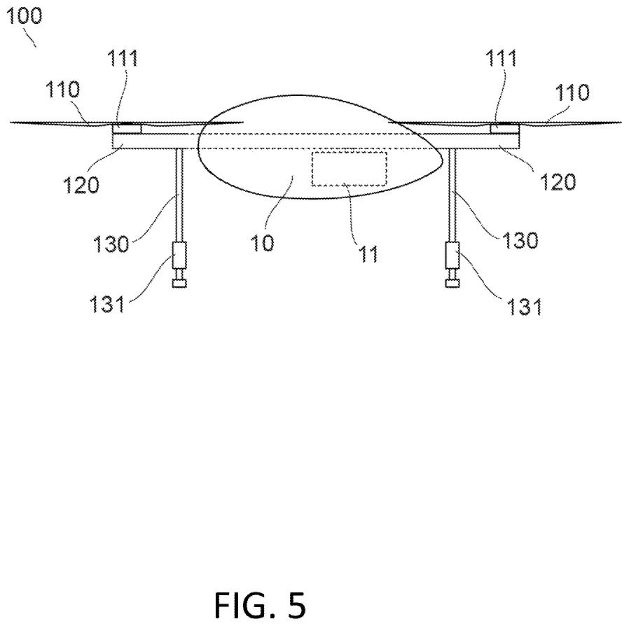

The flying object 100 may be configured to carry a cargo 11 or other objects to be delivered, as shown in FIG. 5.

The flying object 100 takes off from the takeoff point and flies to its destination. Upon reaching its destination, the flying object completes its delivery by landing or detaching its cargo at port 30. After detaching the cargo, the flying object 100 heads to another destination.

As shown in FIG. 5, the flying object 100 according to this disclosure has at least a main body part 10 for flight, a plurality of rotary wing parts comprising a propeller 110 and a motor 111, a motor mount and a frame 120 that support the rotary wing parts, and other elements to operate them and equipped with energy (e.g., secondary batteries, fuel cells, fossil fuels, etc.).

The flying object 100 shown in the figure is depicted in a simplified form to facilitate the explanation of the disclosure's structure, and detailed components such as the control part, for example, are not shown in the figure.

The flying object 100 is moving forward in the direction of arrow D (−Y direction) in the figure. (see below for details).

In the following explanation, the terms may be used according to the following definitions. Forward and backward: +Y and −Y; up and down (or vertical): +Z and −Z; left and right (or horizontal): +X and −X; forward (progression): −Y; backward (retreat): +Y; ascending (upward): +Z; descending (downward): −Z.

The propeller 110 rotates under the output from the motor 111. The rotation of the propeller 110 generates propulsive force to take the flying object 100 off from its starting point, moving object, and landing at its destination. The propeller 110 can rotate to the right, stop, and rotate to the left.

The propeller 110 provided by the flying object of the invention has one or more blades. Any number of blades (rotors) (e.g., 1, 2, 3, 4, or more blades) is acceptable. The shape of the blades can be any shape, such as flat, curved, kinked, tapered, or a combination thereof. The shape of the blades can be changeable (e.g., stretched, folded, bent, etc.). The blades can be symmetrical (having identical upper and lower surfaces) or asymmetrical (having differently shaped upper and lower surfaces). The blades can be formed into airfoils, wings, or any geometry suitable for generating dynamic aerodynamic forces (e.g., lift, thrust) when the blades are moved through the air. The geometry of the vane can be selected as appropriate to optimize the dynamic aerodynamic characteristics of the vane, such as increasing lift and thrust and reducing drag.

The propeller provided by the flying object 100 of the invention may be, but is not limited to, fixed pitch, variable pitch, or a mixture of fixed and variable pitch.

The motor 111 produces rotation of the propeller 110: for example, the drive unit can include an electric motor or engine. The blades can be driven by the motor and rotate around the axis of rotation of the motor (e.g., the long axis of the motor).

The blades can all rotate in the same direction or can rotate independently. Some of the blades rotate in one direction while others rotate in the other direction. The blades can all rotate at the same RPM, or they can each rotate at a different RPM. The number of rotations can be determined automatically or manually based on the dimensions of the moving object (e.g., size, weight) and control conditions (speed, direction of movement, etc.).

The flying object 100 determines the number of rotations of each motor and the angle of flight according to the wind speed and direction by means of a flight controller 1001, ESC 112, transreceiver (propo) 1006, etc. This allows the flying object to perform moving objects such as ascending and descending, accelerating and decelerating, and changing direction.

The flying object 100 can fly autonomously according to routes and rules set in advance or during the flight, or by using a propo/transreceiver 1006 to control the flying object.

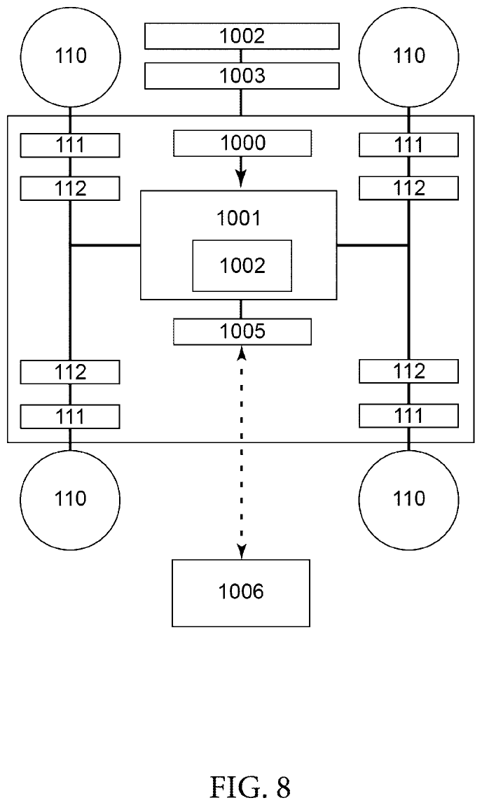

The flying object 100 described above has some or all of the functional blocks shown in FIG. 8. The functional blocks in FIG. 8 are an example of a minimum reference configuration. The flight controller 1001 is a so-called processing unit. The processing unit can have one or more processors, such as a programmable processor (e.g., central processing unit (CPU)). The processing unit has a memory, not shown, which is accessible. The memory stores logic, code, and/or program instructions that can be executed by the processing unit to perform one or more steps. The memory may include, for example, a separable medium such as an SD card, random access memory (RAM), or an external storage device. Data acquired from sensors or the like 1002 may be directly transmitted to and stored in the memory. For example, still and moving image data captured by a camera or other device is recorded in the internal or external memory.

The processing unit includes a control module comprising to control the state of the rotorcraft. For example, the control module controls the propulsion mechanism (e.g., motor) of the rotorcraft to adjust the spatial arrangement, velocity, and/or acceleration of the rotorcraft having six degrees of freedom (translational motion x, y and z, and rotational motion θx, θy and θz). The control module can control one or more of the states of the loads/cargo, sensors, etc.

The processing unit is capable of communicating with a transmission/reception unit 1005 comprised of one or more external devices (e.g., terminal, display, or other remote controller) to transmit and/or receive data. The transceiver 1006 can use any suitable means of communication, such as wired or wireless communication. For example, the transmission/reception unit 1005 can use one or more of the following: local area network (LAN), wide area network (WAN), infrared, wireless, WiFi, point-to-point (P2P) network, telecommunications network, cloud communications, or the like. The transmission/reception unit 1005 can transmit and/or receive one or more of the following: data acquired by sensors 1002, processing results generated by the processing unit, predetermined control data, user commands from a terminal or remote controller, or the like.

Sensors 1002 in this embodiment can include inertial sensors (accelerometers, gyroscopes), GPS sensors, proximity sensors (e.g., lidar), or vision/image sensors (e.g., cameras).

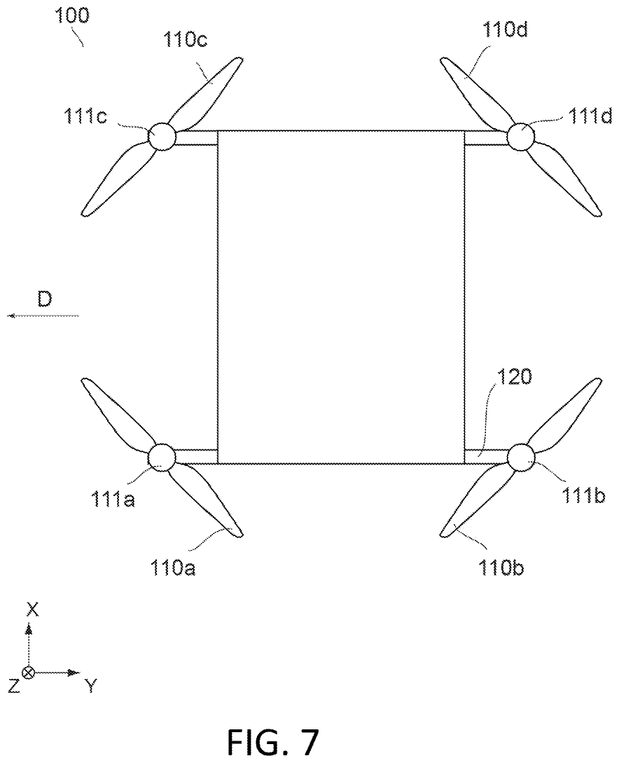

As shown in FIG. 5-FIG. 7, the plane of rotation of the propeller 110 provided by the flying object 100 in this embodiment of the disclosure is at a forward inclined angle toward the direction of travel when traveling. The forward inclined rotating surface of the propeller 110 generates upward lift and thrust in the direction of travel, which propels the flying object 100 forward.

The flying object 100 has a main body part that can contain the onboard processing unit, batteries, and cargo/loads. The main body part is fixedly connected to the flight part, and the main body part changes its attitude as the flight part changes its attitude. The shape of the main body part is optimized to increase the speed and efficiently shorten the flight time in the attitude of the flying object 100 during cruising, which is expected to be maintained for a long time while the flying object 100 is moving.

The main body part should have an outer skin that is strong enough to withstand flight, takeoff and landing. For example, plastic, FRP, or the like are suitable materials for the outer skin because of their rigidity and water resistance. These materials may be the same material as the frame 120 (including arms) included in the flight part, or they may be different materials.

The motor mount, frame 120, and main body part provided by the flight part may be composed of parts connected to each other, or they may be molded as a single unit using a monocoque structure or integral molding (For example, the motor mount and frame 120 can be molded as one piece, or the motor mount, frame 120, and main body part can all be molded as one piece, etc.). By integrating the parts as one piece, the joints between each part can be made smooth, which is expected to reduce drag and improve fuel efficiency of flying objects such as blended wing bodies and lifting bodies.

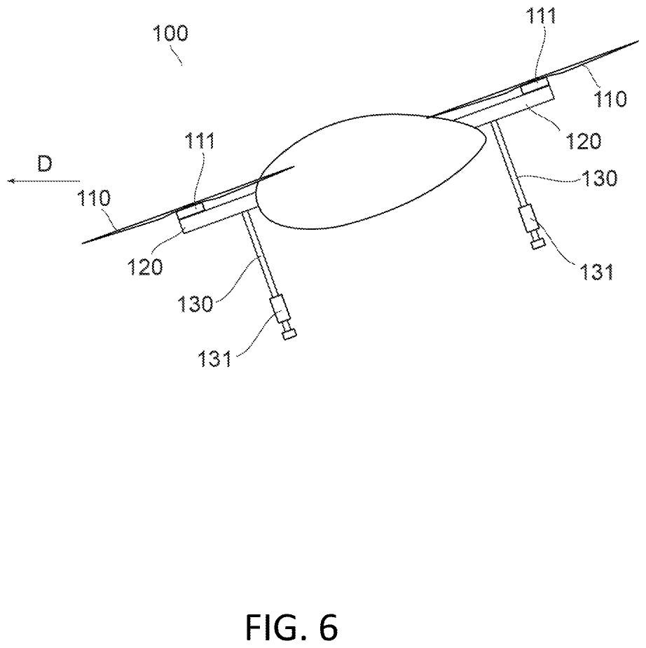

The shape of the flying object 100 may be directional. For example, as shown in FIG. 5 and FIG. 6, the flying object 100 has a streamlined main body part that has less drag in a cruising attitude in no wind, or other shapes that improve flight efficiency when the nose of the flying object is directly facing the wind.

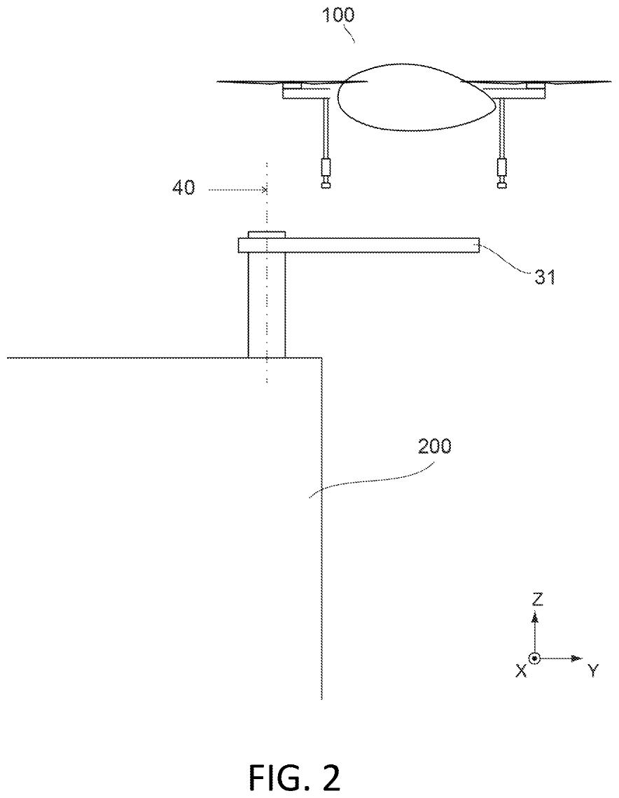

As shown in FIG. 2-FIG. 4, the port 30 has at least two modes: a standby mode in which it does not receive a load and a load-receiving mode in which it receives the load 11 from flying objects 100 or the like. During the standby mode, the load-receiving part 31 is in close proximity to the structure 200. Desirably, this is a position where a person in the building can easily unload the cargo 11 placed on the load-receiving part 31 and is less susceptible to the wind when it blows. More specifically, it can be a position where at least part (or all) of the load-receiving part 31 is inside a building area, such as a common part of the building (e.g., a balcony or hallway) or a private part (e.g., a living room). In the load-receiving mode, the rotation of the rotating part 33 causes the load-receiving part 31 and the support member 32 to rotate in a substantially horizontal direction, moving the load-receiving part 31 to a position further away from the structure than in the standby mode. More specifically, this can be a position where at least part (or all) of the load-receiving part 31 is outside the building area, such as a common or private part of the building.

The rotating axis 40 provided by the rotating part 33 extends in a direction that includes at least a Z-axis component (more preferably, in a direction that includes more of a Z-direction component) and allows the load-receiving part 31 and the support member 32 to rotate. The pivoting may be performed manually or automatically using a hand-cranked handle, an electric motor, an engine, or the like. If automated, the port 30 is equipped with a control unit (not shown). Based on the scheduled arrival time of the flying object, delivery information such as a sign of approach, or a rotation instruction signal from the flying object 100, the rotation is performed at a predetermined timing to receive the cargo. When the operation of port 30 is automated, the switching between standby mode and load-receiving mode and the operation of the fall prevention member 34 (details of the fall prevention member 34 are described below) are controlled by instruction signals from the processing unit provided by either port 30, flying object 100, loading part (load/carg) 11, or external control equipment. The content of the operation control of port 30 may be determined by the type of request signal with which each communicates.

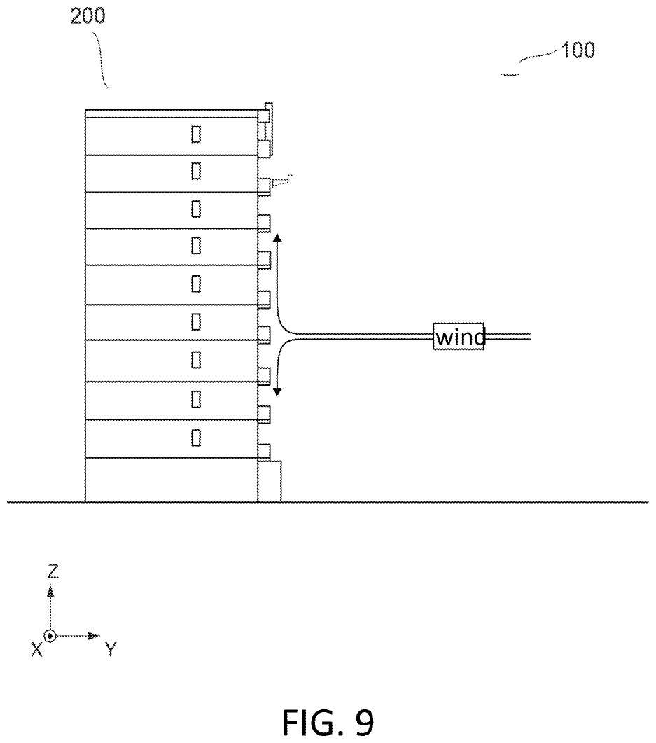

As shown in the schematic shown in FIG. 9, near the walls of the structure 200, wind impinging on the walls produces upward and downward air currents in the front (impact surface) of the structure and strong horizontal wind on the sides of the structure. Since these air currents flow along the wall, it is desirable for the load-receiving part 31 to be more outward and further away from the strong wind flow when in the load-receiving mode. However, if the load-receiving part 31 is moved away from the structure 200, the support member 32 becomes longer. The best configuration of the support member 32 might be determined by the strength and manufacturing cost of the support member 32, the area of the balcony or window, and other factors. For example, the support member 32 may be longer than the length of the load-receiving part 31 in the direction of extension of the support member 32, or twice the length of the load-receiving part 31.

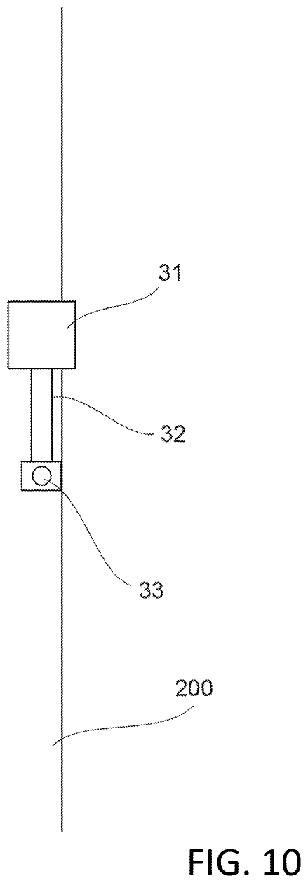

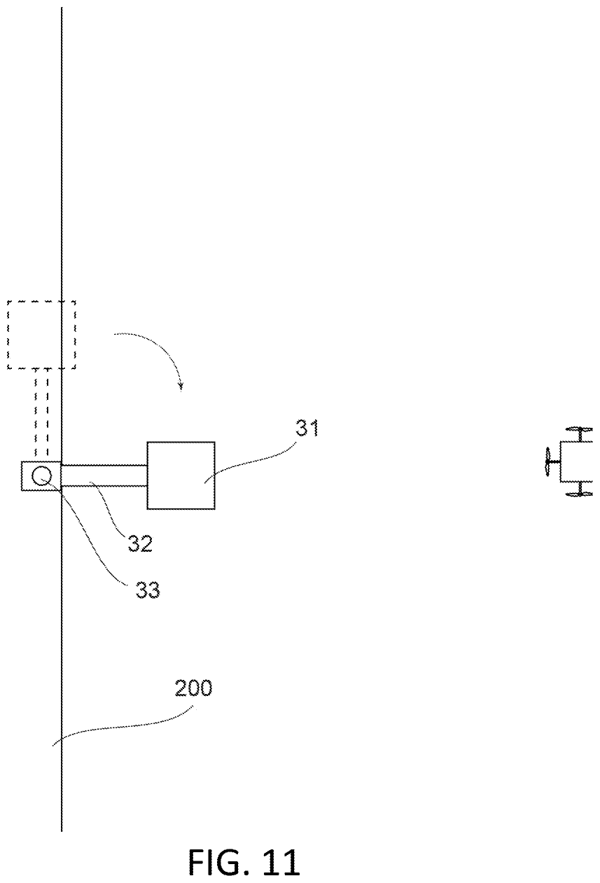

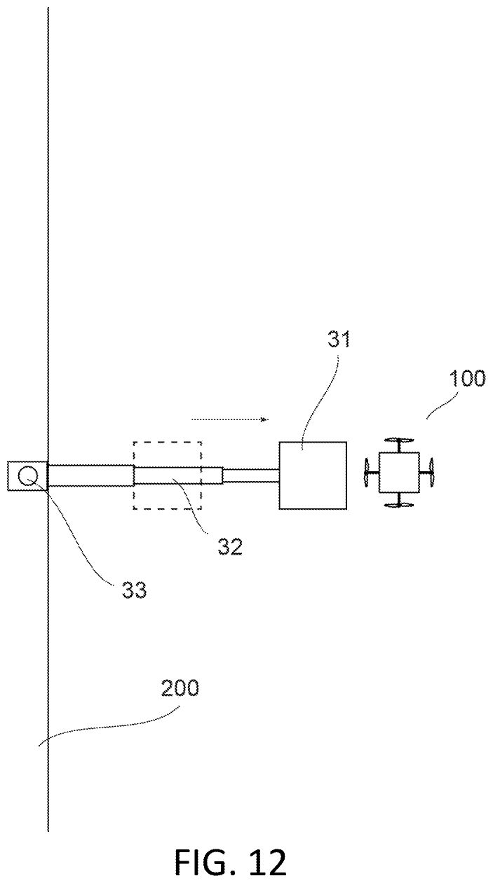

The support member 32 may be provided with a telescopic mechanism so that it can be rotated and then further extended when transitioning to the load-receiving mode, as shown in FIG. 10-FIG. 12. This allows the distance between the structure 200 and the load-receiving part 31 to be increased in the load-receiving mode while reducing the port size expansion in the standby mode.

The telescopic mechanism should be of a structure that can support the load of the load-receiving part 31, etc., preferably one that can be extended and retracted quickly. Examples include, but are not limited to, rod systems using pipes of different diameters, multi-section link mechanisms, and sliding plate members with rails.

In the top view, the width (short side) of the support member 32 provided by port 30 should be shorter than the width (short side) of the load-receiving part 31. As mentioned above, upward airflow may be generated on the wall surface, and the airflow flows along the wall surface. If the support member 32 is wide, the airflow may follow the sides of the support without avoiding it, and the rising airflow may flow up to the load receiving-part 31. In this case, even if the load receiving-part 31 is away from the wall surface, the effect of the upward airflow and other influences may not be sufficiently mitigated.

When the load-receiving part 31 comprises a shape on which cargo 11 can be placed, it should be equipped with a function to prevent the placed cargo 11 from moving or falling due to wind or other factors. Examples of the configuration of the load-receiving part 31 are listed and described below.
(1) A movable wall or fence is provided around the load-receiving part 31.
(2) The floor of the load-receiving part 31 should be stepped or sloped.
(3) Suction by negative pressure.
(4) Temporarily fix the load by using magnetization, adhesion, hook and loop fasteners, etc.
(5) Install a permanent wall or fence around the 31 load-receiving part.

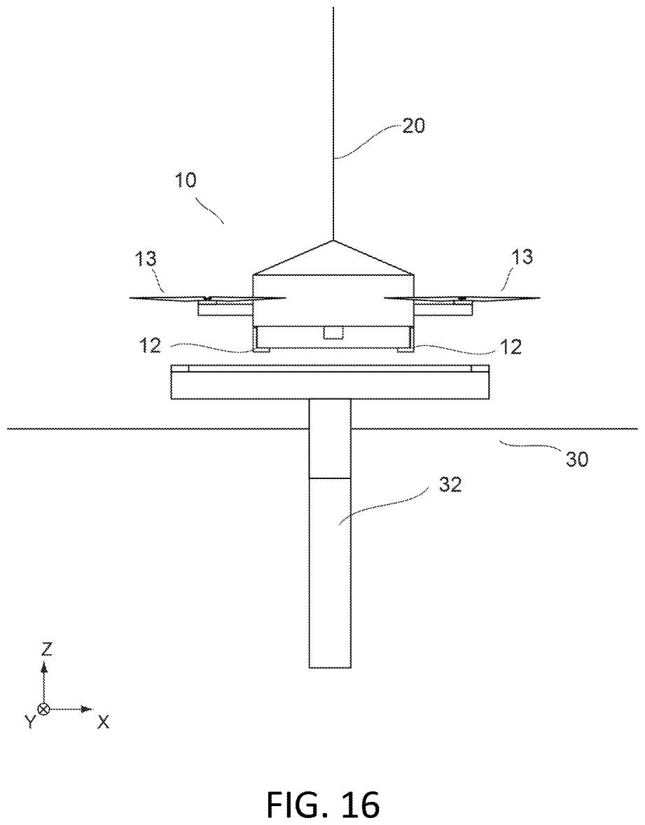

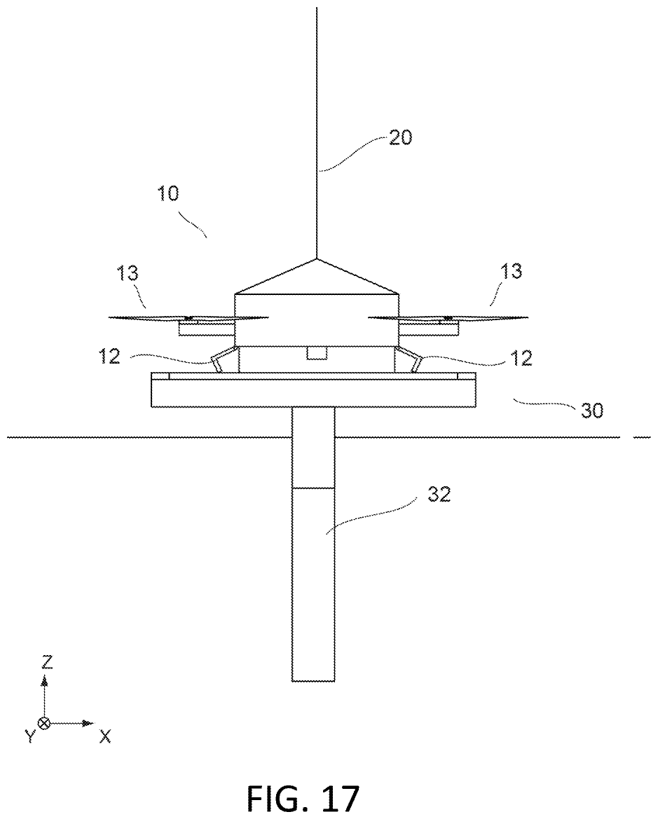

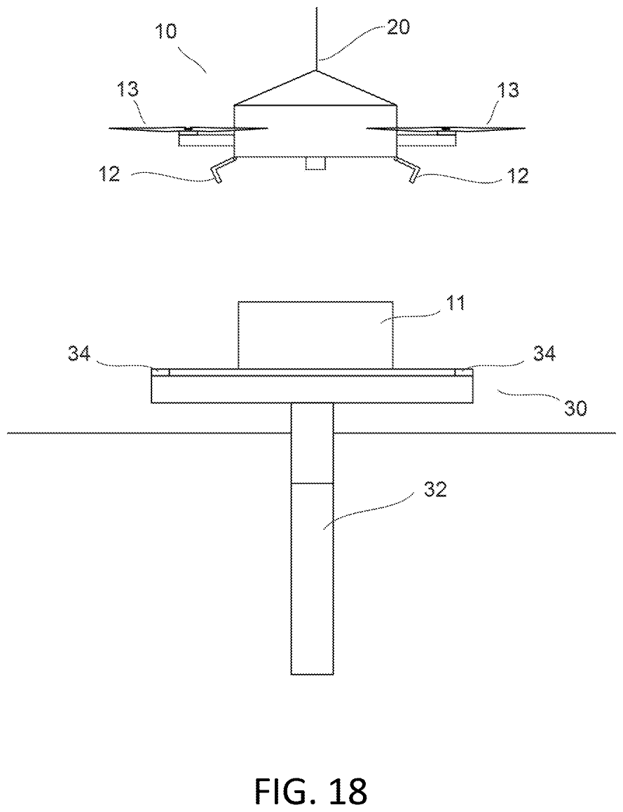

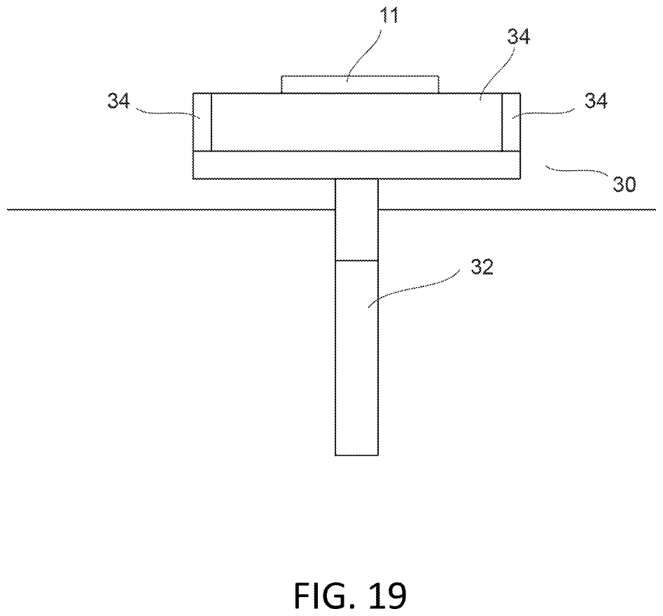

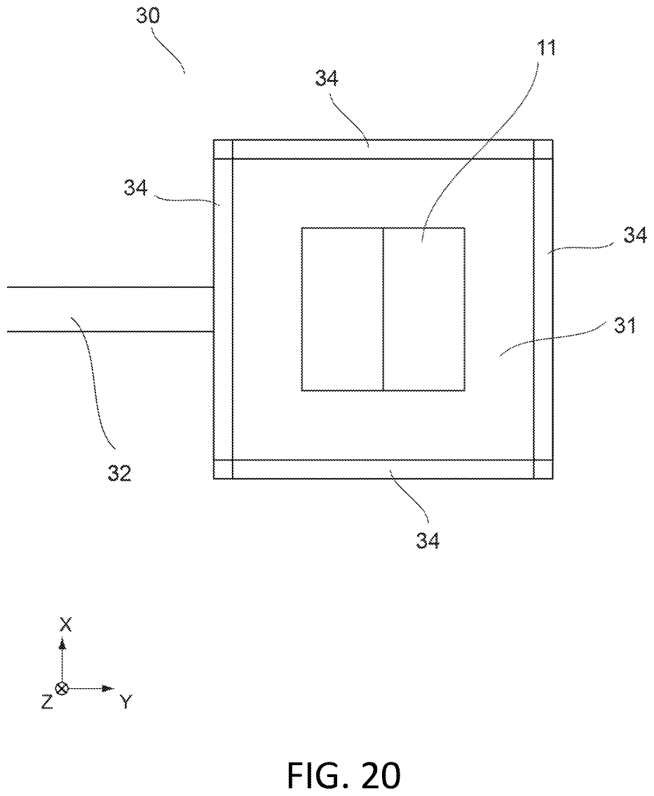

When fall prevention members 34 such as fences or walls are provided as shown in FIG. 16-FIG. 20, if the fall prevention members 34 are always provided high, they may become an obstacle to the landing operation of the flying object 100 or the operation of placing the cargo 11. Therefore, it is desirable to be able to adjust the length of the member extending above the plane by using a mechanism such as telescoping or opening/closing. In the case of cargo that may fall a short distance, the fall prevention member 34 may be made to fall into the enclosed space without being moved.

The load-receiving part 31 may have a flat surface shape on which the flying object 100 can land and place the cargo 11, or it may have arms, robotic hands, etc. for receiving cargo.

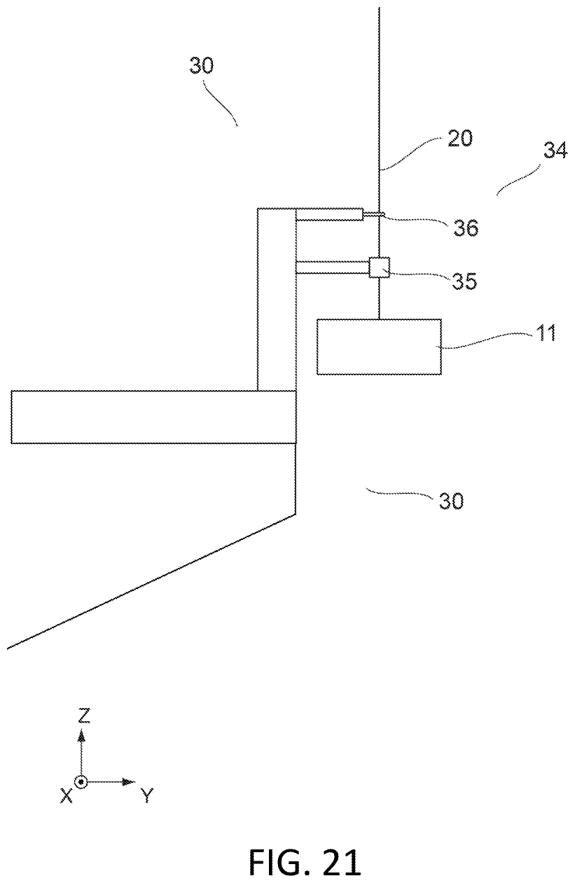

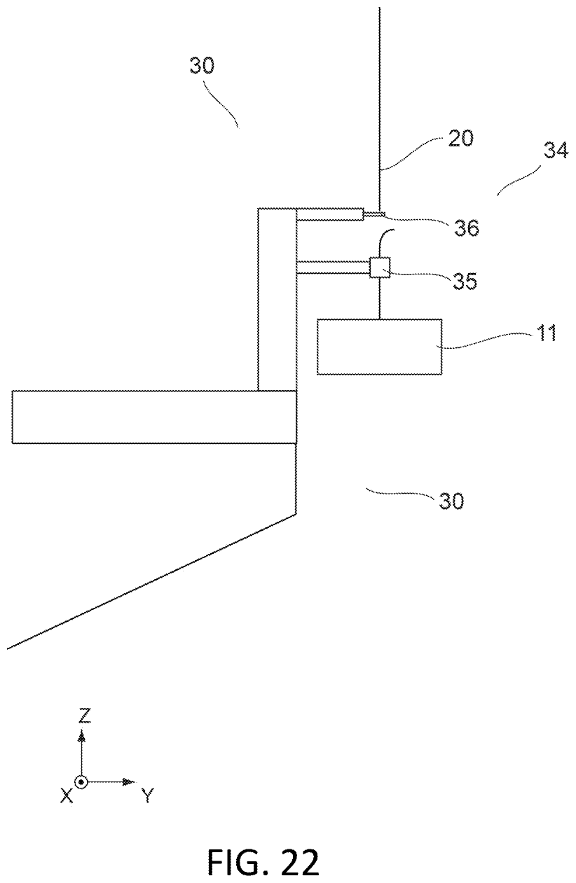

In the case of a system in which the cargo 11 is suspended and lowered from the flying object 100 or the like by a cord-like member 20 (e.g., a long flexible material, such as wire, electrical wire, fishing line, rope, tape, etc.), as shown in FIGS. 21 and 22, for example, by providing a holding mechanism 35 that grabs and holds the cargo 11 and cord-like member 20, and a cutting mechanism 36 for the cord-like member 20 above the holding mechanism 35, it is not necessary to provide a mechanism for separating the cargo 11 from the flying object 100, etc., and the weight increase of the flying object 100 can be controlled. In the configurations of FIG. 21 and FIG. 22, the holding mechanism 35 for grasping the cord-like member is provided below the cutting mechanism of the cord-like member 20, but the arrangement of the cutting mechanism and the holding mechanism is not limited to this.

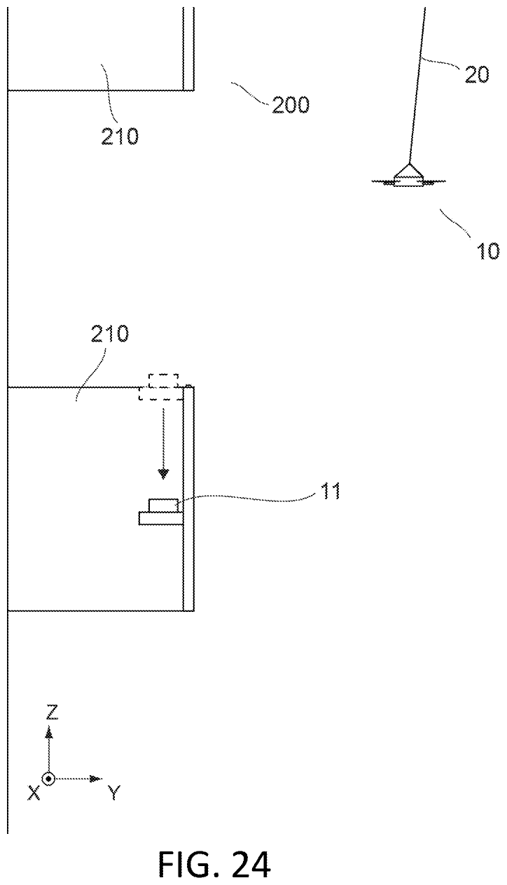

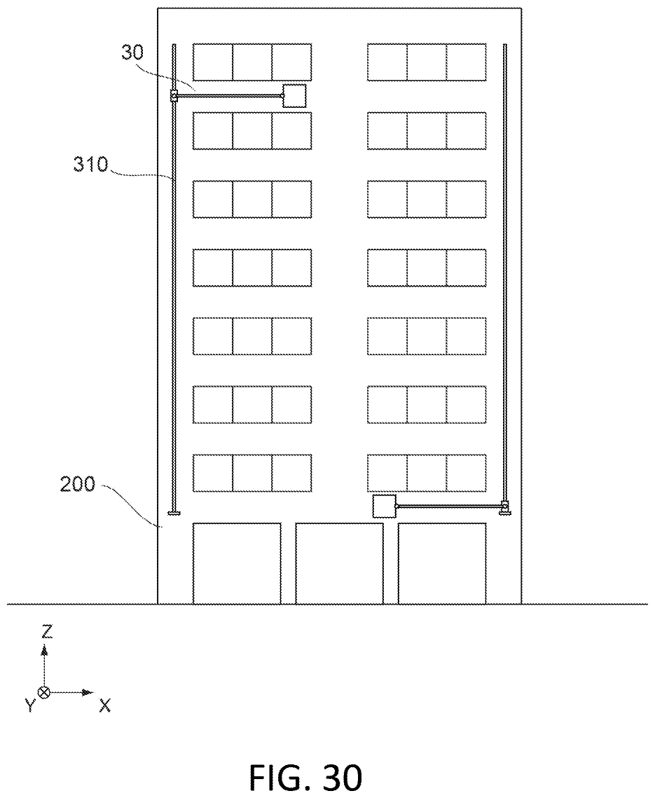

As shown in FIG. 24 and FIG. 30, port 30 may have a function (e.g., elevator, conveyor, etc.) to receive the cargo 11 and then pull the cargo inside the balcony or into a living room. This not only prevents the loss of the received cargo, but also makes it easier for people in the building to access the cargo. In addition, after the cargo has been pulled in, the 31 load-receiving part is ready to receive the cargo again, thereby improving the efficiency of the cargo receiving process.

The support member 32 should be strong enough to withstand the weight of the cargo 11 and other objects placed on it, as well as the pressure exerted by the wind blowing around it. The material and shape of the support member 32 should be selected according to the weight of the cargo to be supported and the conditions of the installation site. For example, if a plate-shaped member is used, it is possible to reduce the pressure exerted by the wind by making multiple holes in the member to allow air to pass through.

In addition, if the structure comprises a combination of pipes (e.g., a truss structure), the cross-sectional shape of the pipes could be an ellipse or symmetrical wing shape instead of a regular circle to reduce the pressure received from wind from a certain direction. In addition, the support member, load-receiving part, and port should comprise shapes and materials that are less susceptible to adverse effects from external influences (in particular, wind and rain), thereby enabling lower maintenance costs and longer service life.

If the port 30 is to be fixed to a structure 200, the structural members, post materials, beam materials, etc. should be determined according to the required strength. If the port 30 is to be installed in an existing building such as an apartment, house, hotel, etc., it is possible to use the balcony railing of the living room for installation. However, if there is a lack of strength, it should be connected to a high-strength structure such as a pillar.

As mentioned earlier, the port 30 may not be secured to the structure 200 to allow for temporary use, or it may be secured in a way that allows for easy attachment and detachment. For example, if the rotating part 33 is connected to a heavy object, such as a pole stand made of concrete or metal, which is heavy enough to withstand the weight of the flying object 100 and cargo 11, the port can be used without being connected to the structure. In addition, the port is suitable for ports intended for short-term use because it can be installed and removed by people or heavy equipment such as cranes.

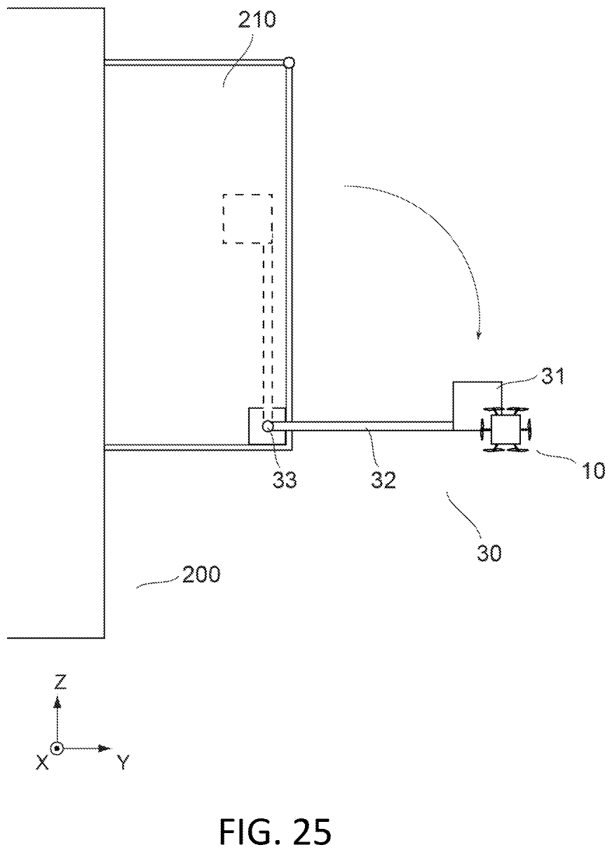

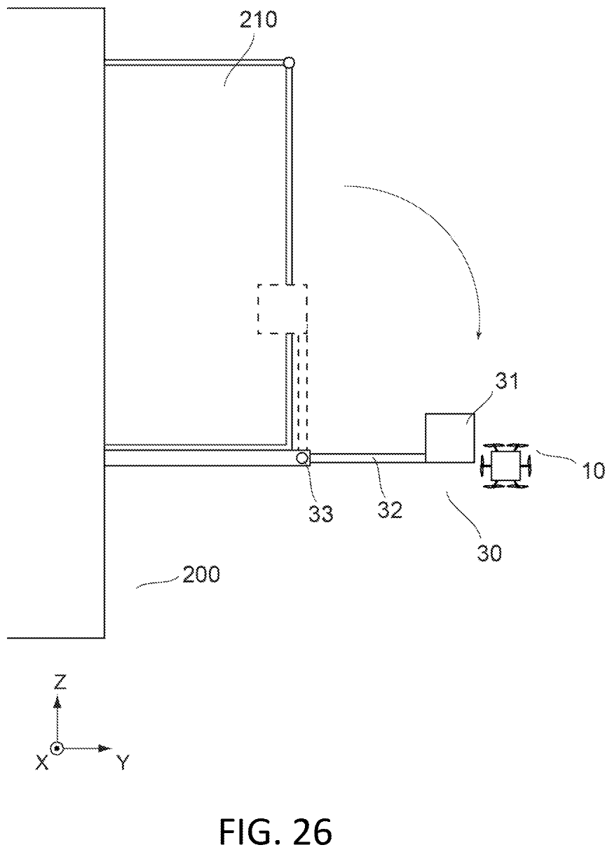

Pole stands that can be used for temporary use of port 30 include those composed of steel or concrete, such as those used for installing signboards or clotheslines, those with tanks for installing flags or parasols, and those with stakes driven into the ground. If the cargo or flying object to be landed is lightweight, the pole stand itself can be made of lightweight materials such as the latter to make it easier to carry, but in terms of stability during rotation and landing, it is preferable to use a pole stand with a heavy weight like the former. As shown in FIG. 25, the port 30 may be a pole stand at a corner of the balcony 210, such that the rotating part 33 is provided on the pole stand. As shown in FIG. 26, the port 30 may be a pole-like structure provided on the outside of the balcony 210 as a pole stand, and the rotating part 33 may be provided at the end of the structure.

Ports that can be relocated can be installed on balconies, windows, etc. of private homes, making it possible to use the ports without building renovations, etc. In addition, at locations used only for a certain period of time (campgrounds, beach houses, tourist attractions, event sites, etc.), the port can be removed from the outdoors during periods of disuse, thus preventing deterioration due to wind and rain, and preventing tampering by third parties.

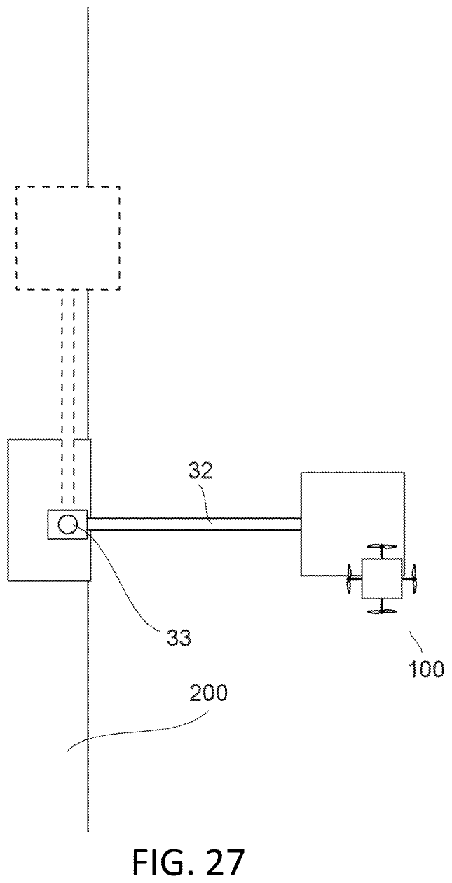

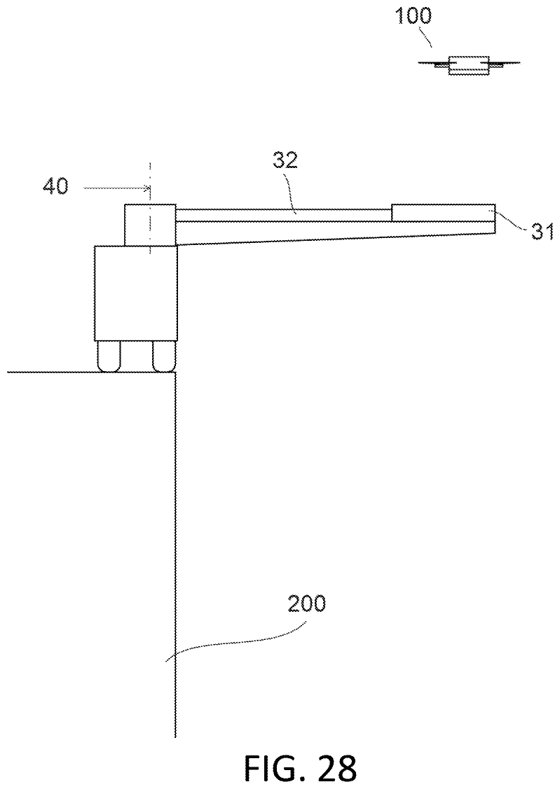

The moving object to which the rotation part 33 as shown in FIG. 27-FIG. 28 is connected may be movable only within a predetermined range, or it may be unrestricted in its movement. For example, if it can be moved by a pulley or other means on rails on the exterior walls of an apartment building, a single port can receive cargo from multiple rooms at different times, thereby reducing the overall number of ports installed. In addition, as shown in FIG. 27 and FIG. 28, when the port is connected to a moving object equipped with self-propelled means, such as a vehicle or a ship, it is not necessary to install multiple permanent ports by setting receiving times within a village and receiving cargo in a given area at a specific time.

The load-receiving part 31 provided by the port 30 should be located at a certain distance or more from the structure 200 from the viewpoint of the effects of the aforementioned upward air currents and other factors. The support member 32 should have a small area or be shaped to have low drag against wind from a given direction in order to prevent influence on the airflow.

In addition, multiple ports 30 may be provided for one structure 200, such as an apartment building or a building. For example, if one port is provided at the window or balcony of each room equipped with openings, it is possible for each room user to have a dedicated port. Compared to the case where users of different rooms take turns using the same port for the cargo 11 they receive, this can be expected to shorten the waiting time, improve the delivery efficiency of the flying object 100 that comes to deliver the cargo 11 by reducing the waiting time for unloading, and reduce the energy consumption of the flying object.

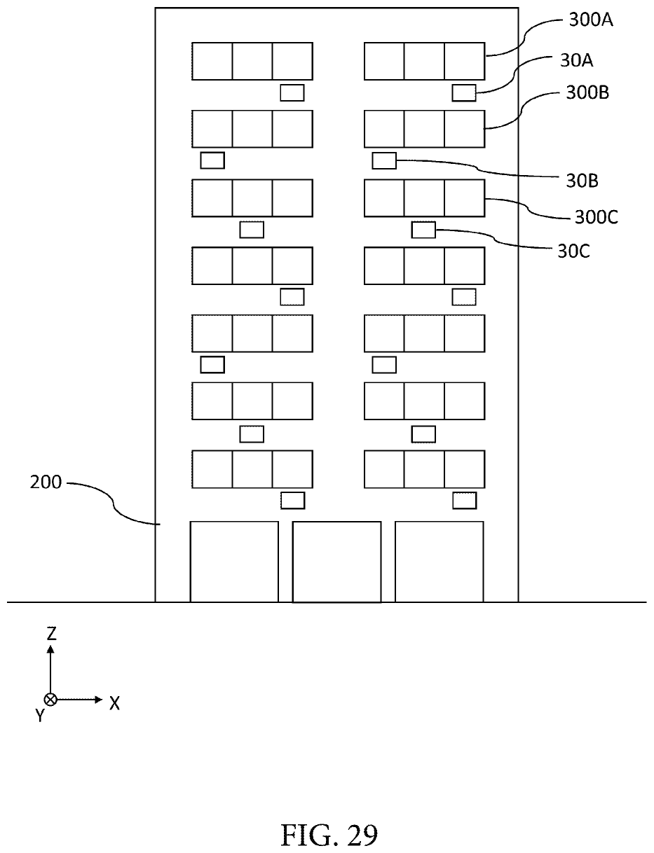

When multiple ports 30 are provided for one structure 200, the multiple ports 30 should be arranged with staggered X coordinates in adjacent rooms above and below. For example, the port 30 is located at the left end of the balcony every other room from the top floor, at the right end of the balcony every other room from the floor directly below the top floor, and so on. In other words, in the structure 200, it is preferable that the X-coordinate positions of the ports 30 are provided at different positions when viewed from the top of the structure 200, between the upper floor and the lower floor rooms. For example, as shown in FIG. 29, the ports 30A, 30B, and 30C in the upper and lower parallel rooms 300A, 300B, and 300C, respectively, in the structure 200 are installed so that the installation positions of the upper and lower floors are different from each other in X coordinates. If the ports 30 are installed so that the X-coordinates are the same or near each other in the structure 200, the port in the room above may become an obstacle for delivery to the port in the room below when the port in the room above and the port in the room below receive cargo at the same time. Therefore, by arranging the ports 30 as shown in FIG. 29, the ports in the upper-floor rooms are less likely to become obstacles to deliveries to the ports in the lower-floor rooms.

In rooms adjacent to each other on the left, right, front, or rear, ports can be provided to allow a wider distance between them to prevent them from becoming an obstacle to receiving cargo. For example, in side-by-side balconies, each port can be placed at the left end of each balcony to allow a certain distance between them.

In some cases, a lifting mechanism is used for unloading, and the cargo 11 is lowered from the flying object 100 by unrolling the string member 20 or other parts. In this case, if a port with a short or no support member 32 is used, the string member 20 is in a position where it can easily come into contact with the lower edge of the balcony above the port 30 where the cargo receiving is performed. To prevent contact between the balcony and the string member, it is desirable to provide clearance by chamfering or other means at the lower edge of the balcony above the balcony where the port is located below. In addition, to prevent deterioration of the string members 20 due to contact, it is desirable to provide protective materials for the string members, such as pulleys, corner pads, and slip-helping tape at the corners of the lower edge of the balcony.

In many cases, such as in detached houses, there are no balconies above the floor. However, when a veranda or a port is installed on the first floor, the roof, eaves, or sheathing of the veranda may come into contact with the string member 20. In this case, too, it is possible to provide an escape area in the area of possible contact or to use a protective material for the 20 string members. The roof or eaves of the veranda can be retracted or stored when the port 30 is in use by using an awning or similar material that can be opened and closed, thereby reducing the possibility of contact with the string members 20.

The use or deployment of ports may be controlled when the spacing between the 30 ports is not sufficient or when it is necessary to improve safety. For example, when a port located on a floor above the port where a cargo is about to be received is in use (cargo receiving mode), the port will not start receiving cargo, and the flying object 100 will be placed on standby or the takeoff time of the flying object 100 itself will be delayed. This allows flying objects used for delivery to each port to fly and unload with fewer obstacles. Even in cases where cargo 11 is lowered from the flying object by unrolling the string member 20, it is possible to prevent the cargo 11 and string member 20 from coming into contact with or becoming entangled with the port on the upper floor.

Port deployment control may be performed by communication from the entire delivery system to manage and control multiple delivery schedules, or by sending signals to the port side from the flying object 100 or the loading part (load/cargo) 11 approaching port 30. When ports 30 communicate with each other to share usage status and control instructions to the port downstairs, part of the control can be completed within the structure.

By enabling deployment control of port 30, it is also possible to specify the behavior of port 30 other than when receiving cargo. Examples of behavior by deployment control are listed and described below.
(1) When the number of cargo receiving at a particular port becomes excessive, other vacant ports will accept cargo on behalf of the port. Alternatively, a proxy port may be set up in advance on the rooftop, in an empty room, or in a building manager's office to accept cargo on behalf of another port.
(2) In the event of a fire or other emergency, the management server will control or equip a communication device that communicates directly with the port in the event of emergency to uniformly stop receiving cargo at the port.
(3) The port is placed in standby mode when an event that may pose a danger to the flying object 100 or port 30, such as an earthquake early warning, localized strong winds, or a downburst, is detected by an anemometer or other sensor or environmental information such as weather information.
(4) When a signal requesting landing is received from an external flying object in flight, the port that is not in use or not scheduled to receive cargo is deployed to the receiving mode.
(5) Even if cargo reception is not performed as scheduled due to a flying object failure or a cargo disconnection error, if the elapsed time, etc. exceeds the threshold value, the mode is shifted from the cargo receiving mode to the standby mode.
(6) If, during the cargo receiving mode, the sun's position causes the shadow of the port to fall on the downstairs or adjacent rooms, the deployment position is controlled to the position where the shadow is minimized.

### Details of the Second Embodiment

In the details of the second embodiment of this disclosure, the components that overlap with those of the first embodiment operate in the same manner, thus they are omitted from the description again.

In recent years, various forms of flying objects have been considered and implemented for use in industries other than home delivery (e.g., inspection, survey, photography, surveillance, agriculture, disaster prevention, etc.). In some operational environments, it may be difficult to provide a landing space for flying objects. For example, when inspecting bridges at high elevations, there are cases where it is impossible to approach the bridges due to the distance from the ground, rivers, the sea, and other factors. In such cases, it is desirable for flying objects to be able to take off and land from the bridge. However, it may be difficult to prohibit the passage of third parties, or it may not be possible to provide sufficient space to ensure the safety of people around flying objects during takeoff and landing.

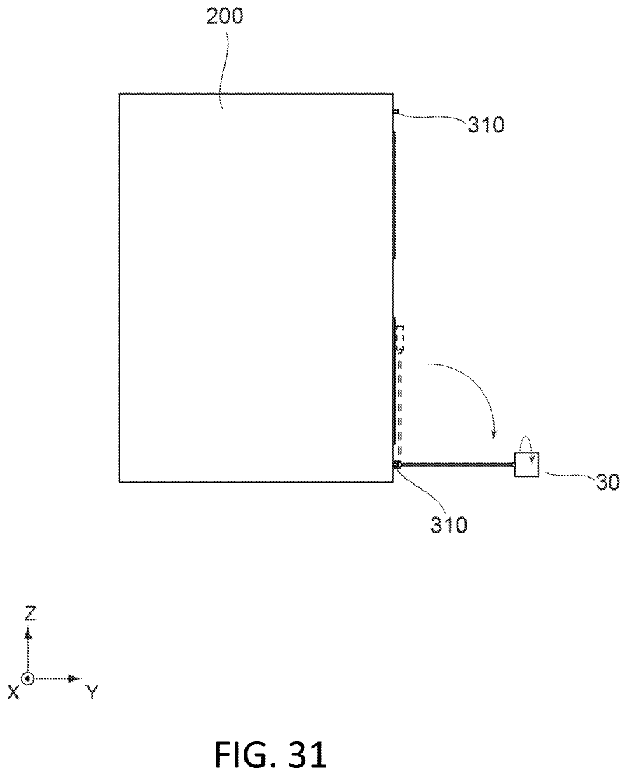

The rotating part 33 may be connected to a moving object (e.g., vehicle, ship, train, etc.). The moving object 300 may be movable only within a predetermined range, or it may be unrestricted in its movement. For example, as shown in FIG. 30 and FIG. 31, if the mobile unit is movable on rails 310 by means of pulleys or other means, it is possible to set up ports in more suitable positions, left to right or up and down, as the inspection of a bridge or building exterior wall proceeds from end to end, as the inspection proceeds. In addition, when the port is installed in connection with a moving object equipped with self-propelled means, such as a vehicle or vessel, as shown in FIG. 27-FIG. 28, the port can be used even in locations where rails or other components have not been installed in advance or where installation is difficult. Even when the port is provided on such a moving object that can move freely, the space required for rotating part 33 and the time required for rotating part is expected to be reduced compared to when the moving object itself changes direction.

Thus, in the port 30 of the second embodiment, unloading and takeoff/landing of flying objects are performed with the distance between the vicinity of the load-receiving part 31, where the flying object 100 actually approaches, and the vicinity of the rotating part 33, where the port is installed, separated by the rotating part 33. For example, when work involving takeoff and landing of flying objects is performed on a bridge, a takeoff and landing port is installed on the bridge (road, etc.), which requires a lot of space and may bring flying objects with rotating propellers close to surrounding people. By using the port 30 of the disclosure, the load-receiving part 31, where the flying object actually takes off and lands, can be pushed out into the air outside of the bridge, thus allowing a greater distance between people and the flying object, and reducing the area of the port on the bridge.

As shown in FIG. 1-FIG. 4, the port 30 according to the embodiment of this disclosure is used in combination with a flying object 100. The flying object may be able to carry cameras, sound-collecting equipment, sensors, particle spraying equipment, liquid spraying equipment, inspection equipment such as percussion testing, and work parts such as robot hands and tools to perform a given task. These mountings can be connected via one or more axes so that they can be displaced independently of the flying object.

It is possible to comprise more than one flying object in each of the embodiments. It is desirable to comprise a suitable configuration in accordance with the cost in manufacturing the flying object and the environment and characteristics of the location where the flying object will be operated.

The above mentioned embodiments are merely examples to facilitate understanding of the disclosure and are not intended to be construed as limiting the disclosure. It goes without saying that the disclosure may be changed and improved without departing from its purpose, and that the disclosure includes its equivalents.

### DESCRIPTION OF REFERENCE NUMERALS

10 Loading part
11 Loads, cargo
12 Load holding mechanism
13 Rotary wing part
20 String member
21 Winch
30 Port
31 Load-receiving part
32 Support member
33 Rotating part
34 Fall prevention member
35 Holding mechanism
36 Cutting mechanism
40 Rotating axis
100 Flying object
110a-110e Propellers
111a-111e Motors
200 Structure
210 Balcony
300 Moving object
310 Rail

1. A port comprising: a load-receiving part that rotates around a rotating axis extending in at least a vertical direction,
wherein the load-receiving part is rotated to switch between a load-receiving mode and a standby mode based on an external control signal.

2. The port according to claim 1,
wherein the control signal is a control signal transmitted from a loading unit that is suspended from a flying object.

3. The port according to claim 1,
wherein the control signal is a control signal transmitted from another port.

4. The port according to claim 1,
wherein the control signal is a control signal transmitted from a flying object.

5. The port according to claim 1,
wherein the control signal is a control signal transmitted from a management server that manages a delivery.

6. The port according to claim 1,
wherein the load-receiving part is connected to the rotating axis via a long support member.

7. The port according to claim 6,
wherein the length of the long support member is longer than the length of the load-receiving part in the direction of extension of the support member.

8. The port according to claim 6,
wherein the support member has a telescopic mechanism.

9. The port according to claim 1,
wherein the load-receiving part has an anti-fall member.

10. The port according to claim 1, further comprising:
a holding mechanism for holding a cord-like member from which a load or a loading part suspended from a flying object; and
a cutting mechanism for cutting the cord-like member.

11. (canceled)

12. A method for installing a plurality of ports for arranging the ports according to claim 1 in a predetermined plurality of rooms of a building,
wherein the ports are arranged in the living rooms adjacent to each other in the upper and lower positions so as not to overlap when viewed from above.

13. The port according to claim 1, further comprising:
moving means for moving the port.
